(19) United States
(12) Patent Application Publication
(10) Pub. No.: US 2022/0138856 A1
(43) Pub. Date: May 5, 2022

(54) Recommendation System For Generating Personalized And Themed Recommendations On A User Interface Based On User Similarity

(71) Applicant: TD Ameritrade IP Company, Inc., Omaha, NE (US)

(72) Inventors: Logan Sommers AHLSTROM, Ann Arbor, MI (US); Anjana AGARWAL, Elliot City, MD (US); Alexander AYZENBERG, Suffern, NY (US); David William MARNE, Omaha, NE (US); Elizabeth Spurny MCKEE, Omaha, NE (US); Ravindra Reddy TAPPETA VENKATA, Novi, MI (US)

(21) Appl. No.: 17/088,612

(22) Filed: Nov. 4, 2020

(51) Int. Cl. G06Q 40/06; G06F 16/245; G06N 20/00

(52) U.S. Cl. CPC G06Q 40/06; G06N 20/00; G06F 16/245

(57) ABSTRACT

An asset recommendation system includes a processor and a memory. The memory stores an aggregated database including user identifiers. The user identifiers correspond to user information. The memory stores instructions for execution by the at least one processor. The instructions include, for each user identifier, generating a user representation based on the user information included in the aggregated database. The instructions include identifying, from the user representations of the user identifiers, a set of similar user representations based on a first user representation corresponding to a first user identifier. The instructions include obtaining, for a set of similar user identifiers corresponding to the set of similar user representations, a set of asset identifiers associated with the set of similar user identifiers. The instructions include transforming an interface of a user device of the first user identifier by rendering a graphical depiction of the set of assets identifiers.

### FIELD

The present disclosure relates to user interfaces and more particularly to systems and methods for generating recommendations based on user-specific parameters.

### BACKGROUND

Financial investment platforms often include performance history and information defining each security in which users can invest. However, additional information about the entity or company that corresponds with the security may require a user to conduct independent research. In this way, a lot of securities are not linked based on similar themes or based on which users invest in which securities. For novice users or investors, in particular, a lack of information about entities on the financial platform makes investing based on the user's interests more difficult.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An asset recommendation system includes at least one processor and a memory coupled to the at least one processor. The memory stores an aggregated database including user identifiers. The user identifiers correspond to user information. The memory stores instructions for execution by the at least one processor. The instructions include, for each user identifier, generating a user representation based on the user information included in the aggregated database. The instructions include identifying, from the user representations of the user identifiers, a set of similar user representations based on a first user representation corresponding to a first user identifier. The instructions include obtaining, for a set of similar user identifiers corresponding to the set of similar user representations, a set of asset identifiers associated with the set of similar user identifiers. The instructions include transforming an interface of a user device of the first user identifier by rendering a graphical depiction of the set of assets identifiers.

In other features, the aggregated database includes entity identifiers and the entity identifiers correspond to entity information. In other features, the instructions include, for each entity identifier, generating an entity representation based on the entity information included in the aggregated database. In other features, the instructions include identifying, from the entity representations of the entity identifiers, a set of similar entity representations based on the first user representation and including a set of entity identifiers corresponding to the set of similar entity representations in the set of assets identifiers.

In other features, the instructions include, in response to receiving a query from the user device, identifying the set of similar entity representations based on the query. In other features, the instructions include updating the aggregated database by retrieving user information and entity information from databases and integrating the user information and entity information into the aggregated database using a corresponding template.

In other features, each database corresponds to a template, and the template includes instructs to normalize data retrieved from the corresponding database. In other features, the aggregated database is updated with data from a first set of databases in real-time and data from a second set of databases at threshold intervals.

In other features, the instructions include obtaining, for the set of similar user identifiers, a performance history of a corresponding similar user portfolio over a threshold period, obtaining, for the first user identifier, a first user performance history of a first user portfolio over the threshold period, and removing user identifiers from the set of similar user identifiers in response to the corresponding performance history of the corresponding similar user portfolio being less than the first user performance history of the first user portfolio.

In other features, the performance history indicates a total asset value change over the threshold period. In other features, the instructions include filtering the set of assets identifiers based on a performance history over a threshold period. In other features, the instructions include updating the set of similar user identifiers for each user identifier at a threshold interval.

An asset recommendation method includes, for each user identifier, generating a user representation based on user information included in an aggregated database. The aggregated database includes the user identifiers. The user identifiers correspond to user information. The method includes identifying, from the user representations of the user identifiers, a set of similar user representations based on a first user representation corresponding to a first user identifier. The method includes obtaining, for a set of similar user identifiers corresponding to the set of similar user representations, a set of asset identifiers associated with the set of similar user identifiers. The method includes transforming an interface of a user device of the first user identifier by rendering a graphical depiction of the set of assets identifiers.

In other features, the asset recommendation method includes, for each entity identifier, generating an entity representation based on entity information included in the aggregated database. The aggregated database includes the entity identifiers. The entity identifiers correspond to entity information. In other features, the method includes identifying, from the entity representations of the entity identifiers, a set of similar entity representations based on the first user representation and including a set of entity identifiers corresponding to the set of similar entity representations in the set of assets identifiers.

In other features, the asset recommendation method includes, in response to receiving a query from the user device, identifying the set of similar entity representations based on the query. In other features, the asset recommendation method includes updating the aggregated database by retrieving user information and entity information from databases and integrating the user information and entity information into the aggregated database using a corresponding template.

In other features, each database corresponds to a template, and the template includes instructs to normalize data retrieved from the corresponding database. In other features, the aggregated database is updated with data from a first set of databases in real-time and data from a second set of databases at threshold intervals.

In other features, the asset recommendation method includes obtaining, for the set of similar user identifiers, a performance history of a corresponding similar user portfolio over a threshold period. In other features, the method includes obtaining, for the first user identifier, a first user performance history of a first user portfolio over the threshold period and removing user identifiers from the set of similar user identifiers in response to the corresponding performance history of the corresponding similar user portfolio being less than the first user performance history of the first user portfolio.

In other features, the performance history indicates a total asset value change over the threshold period. In other features, the asset recommendation method includes filtering the set of assets identifiers based on a performance history over a threshold period. In other features, the asset recommendation method includes updating the set of similar user identifiers for each user identifier at a threshold interval.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a high-level example block diagram of a recommendation generation system.

FIGS. 2A-2B are representations of example user interfaces for recommendation generation and display.

FIGS. 3A-3B are representations of example user interfaces presenting a search for particular securities.

FIG. 4 is a functional block diagram of an example aggregation module.

FIG. 5 is a functional block diagram of an example recommendation generation module.

FIG. 6 is a flowchart depicting example data aggregation from a plurality of databases.

FIG. 7 is a flowchart depicting example updating a recommended investment list based on similar users.

FIG. 8 is a flowchart depicting example recommended content or entities displayed on a user interface.

In the drawings, reference numbers may be reused to identify similar and/or identical elements.

### DETAILED DESCRIPTION

A recommendation generation system provides users with security recommendations based on the user's interaction with a financial platform as well as the values of an entity associated with the security. To generate a set of recommendations, the recommendation generation system aggregates data for users of the financial platform as well as data for entities associated with securities available on the financial platform. The data collected for users includes portfolio structure, social media, the user's interaction with the financial platform (including clicks, content consumed, searches performed, etc.), trading activity by the user, etc. The data collected for entities includes a social responsibility score, news articles mentioning the entity, social media posts about and by the entity, financial performance, etc.

The recommendation generation system provides data aggregation and portfolio personalization in an interface. Users will be able to identify and invest based on their values, interest, and passions. For example, a user can search for investments and securities using key terms, such as “clean energy.” The recommendation generation system will receive the query and implement natural language processing or other machine learning algorithms to identify relevant “tags” or important terms. Using the aggregated database, the recommendation generation system can identify which entities correspond to the important terms and relevant tags using a vast amount of data, including current news articles, social media posts, social responsibility score, etc. to find recommendations for the user based on the user's search.

Additionally, the recommendation generation system can identify users similar to other users and generate a recommended investment list based on the investments of similar users. The recommendation generation system can regularly update a list of similar users for users of the platform. For example, while data may be consistently being aggregated into an aggregated database including information for users as well as entities, the list of similar users may only be updated on an hourly or daily basis using the updated aggregated database. Then, when a user logs in to their account with the financial entity, on the homepage or another webpage, the most recent recommended investment list based on the list of similar users is displayed.

In various implementations, the recommendation generation system can also offer recommended securities or content items in real-time. For example, if a user is navigating through a webpage associated with a financial entity or financial investment entity, the recommendation generation system can monitor the user's clicks and what content the user is consuming. Based on the user's session, the recommendation generation system can implement a machine learning algorithm to determine what content or securities the user may be interested in based on the content the user is currently consuming. The recommendation generation system can analyze the user's current session compared to data aggregated into the aggregated database to identify entities or users who interacted similarly with the platform to anticipate what the user might want to read or navigate to next. Then, the recommendation generation system can display links to particular content items or display a link to a particular security the user may want to learn about.

The aggregated database provides a rich database of user sentiment and entity or security categorization. Additional processing of the data included in the aggregated database may be performed to convert entity names and any key issue, tag, or granular subsector information into foreign identifiers for efficient joining and cross-referencing of information.

As described in more detail below, the recommendation generation system provides both real-time- and batch-based personalization. Implementing real-time and batched machine learning analysis to (i) generate real-time recommendations of content items or securities and (ii) identify similar users at predetermined intervals balances responsiveness and accuracy of modeling. Further, implementing both real-time and batched analysis provides rapid recommendations that are based on deeper and more complex analysis. For the real-time implementations, user data, including user clicks, may be processed using a machine learning model that implements a lightweight probabilistic model and returns a next item to display to the user based upon the likelihood of the user being interested in the next item, which may be a content item such as an article. In various implementations, the real-time machine learning model may implement fast text matching algorithms that search the aggregated database for entities or securities that are associated with or correspond to the item the user has selected or the next item identified.

To identify similar users, the recommendation generation system may implement a batch or interval approach. The recommendation generation system may perform calculations, for example, an hourly, a daily, or other time interval, that compare all users to every other user to find similar users. These batch calculations consider and identify new user behaviors to frequently update which users are most similar to other users. The recommendation generation system combines social metrics and user behaviors with significant financial metrics to make recommendations to users based on which securities similar users are invested. Additionally, the recommendation generation system may provide reasoning behind the recommendations presented to users. For example, when displaying a recommendation, the recommendation generation system may also include that similar users invested in the displayed security or that the displayed security is commonly invested in among newer investors. In various implementations, the recommendation generation system may generate a score indicating how well-matched the recommended security is to the user.

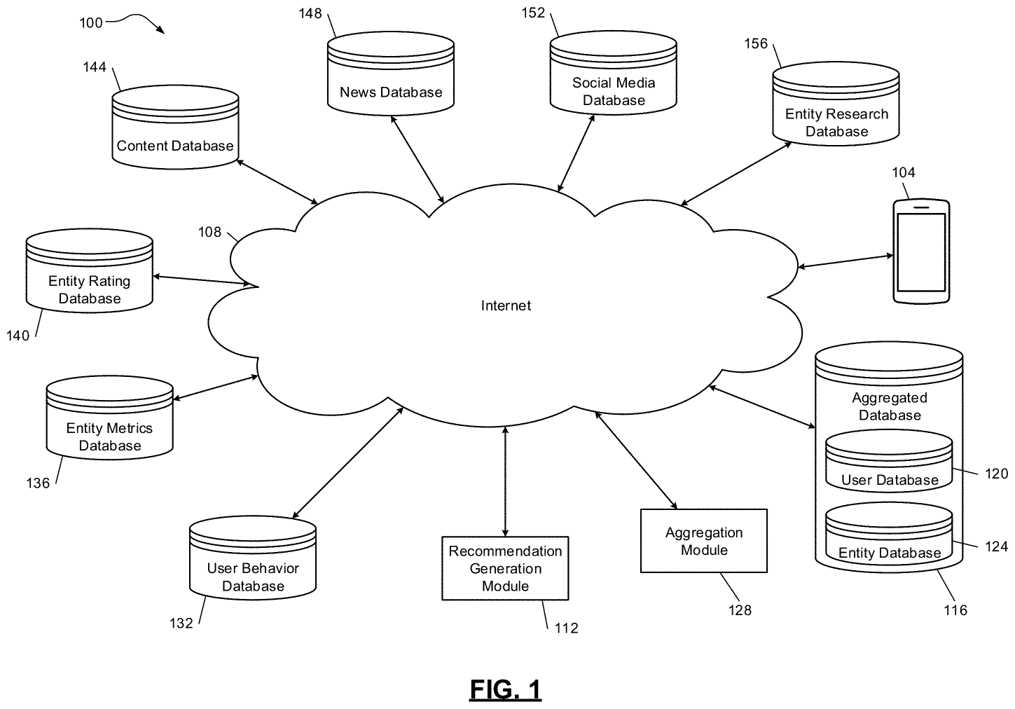

FIG. 1 is a high-level example block diagram of a recommendation generation system 100. A user can access their account with an entity, for example, a financial institution, using a user device 104. The user can log in to their account using the user device 104 to access their financial accounts, execute a trade, consume educational content, such as financial videos, articles, etc. The user device 104 is a computing device, such as a mobile phone, tablet, computer, etc. The user device 104 can access, via the Internet 108, a recommendation generation module 112 to search for investments. The recommendation generation module 112 can generate recommendations based on text input by the user to query the recommendation generation module 112. Additionally, the recommendation generation module 112 can access an aggregated database 116.

The aggregated database 116 may include a user database 120 and an entity database 124. In various implementations, the user database 120 and the entity database 124 may be a single database. The user database 120 includes information related to each user, such as portfolio structure, demographic data, content consumed on the financial entity's platform, etc. The entity database 124 includes information for entities corresponding to assets or securities that users can purchase or sell through the financial entity. For example, the entity database 124 may include for each entity a social responsibility score, social media use, news about the entity, security cost and performance data, etc.

An aggregation module 128 updates the aggregated database 116 by accessing and combining data from a user behavior database 132, an entity metrics database 136, an entity rating database 140, a content database 144, a news database 148, a social media database 152, and an entity research database 156. The user behavior database 132 may store information regarding the portfolio structure of users, user demographics, user trading activity, entity platform usage (such as clicks performed by the user, content viewed by user), etc. The entity metrics database 136 may include performance metrics of entities available for trade through the financial entity, such as historical price performance and other entity quantitative metrics.

The entity rating database 140 may include environmental and social governance ratings for a variety of entities as well as entity relationships to key issues, such as clean energy, etc. The content database 144 may include a plurality of investor education content items, including videos, articles, webcasts, courses, etc. The news database 148 may be a live news feed providing updated information occurring in the news about the plurality of entities. The social media database 152 may provide updated social media posts and information related to entities and/or users. The entity research database 156 may include information regarding entity competitors and entity analytics regarding acquisition and mergers, deals, etc.

The aggregation module 128 obtains data from the described databases and aggregates the information into the aggregated database 116. In various implementations, the aggregation module 128 extracts data from each data source using a corresponding template to normalize the data stored in the aggregated database 116. The aggregated database 116 is indexed by entity and/or user to store aggregated data related to a particular user identifier in the user database 120 and store aggregated data related to a particular entity identifier in the entity database 124.

The recommendation generation module 112 obtains aggregated data for particular users to display recommended securities on a user interface of the user device 104. The recommended securities displayed to the user are determined by identifying users similar to the particular user and selecting securities in which similar users invest. The recommendation generation module 112 also implements machine learning to select securities through a search conducted by the user. The recommendation generation module 112 also monitors the particular user's platform interaction or usage to generate, in real-time, recommended content or securities based on the platform usage and the aggregated data.

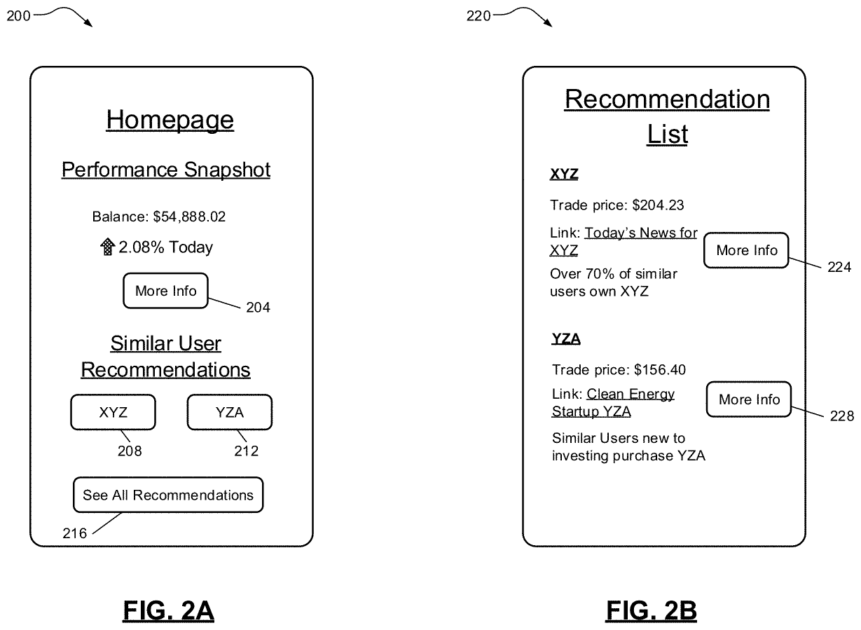

FIGS. 2A-2B are representations of example user interfaces for recommendation generation and display. FIG. 2A depicts an example user interface displaying a homepage 200. The user may log on to their account operated by the financial entity through the user device 104 of FIG. 1. The homepage 200 may include a performance snapshot of the user's portfolio showing a present balance and a change in balance for the present day. A more info button 204 may be selected by the user to navigate the user to a webpage including present investments, a list of an amount the user has invested in each security, and additional portfolio information.

The homepage 200 may also include a similar user recommendations section. The similar user recommendations section lists one or more securities or assets that the user may want to invest in because users similar to the user have invested in these securities. As shown on the homepage 200, the recommendation generation system 100 of FIG. 1 identifies users similar to the user and generates user-selectable links to securities in which those similar users are invested. An XYZ button 208 links the user to information about the XYZ security and a YZA button 212 links the user to information about the YZA security. The homepage 200 may also include a see all recommendations button 216 which links the user to a full list of recommendations along with additional information about the recommendation, as shown in FIG. 2B.

In various implementations, the homepage 200 includes validation information for each recommendation. The validation information indicates why a particular security or investment is suggested to the user. FIG. 2B depicts a recommendation list 220 on the user interface of, for example, the user device 104 of FIG. 1. The recommendation list 220 includes the name of the security (XYZ or YZA) a trade price ($204.23 or $156.40), a link to an article about the entity corresponding to the security (Today's News for XYZ or Clean Energy Startup YZA), and a reason why the security was selected (over 70% of similar users own XYZ or similar users new to investing purchase YZA).

Each security has a corresponding more info button 224 and 228, linking the user to additional information about the security, including price history and performance, links to other news articles, etc. The recommendation generation system 100 of FIG. 1 not only identifies those investments commonly held by similar users but is also transparently presenting to the user why the particular security was selected and recommended to the user. In various implementations, upon selection of the corresponding more info button 224 and 228, validation information may be displayed to the user. For example, the validation information may state that a percentage of investors, such as 60%, with recent trading volume and asset-class allocation similar to the users hold the recommendation security. In a further example, the validation information may include that entity YZA relates to the user's interest in a particular theme, such as clean energy, and the recent price volatility of YZA fits with the user's risk tolerance.

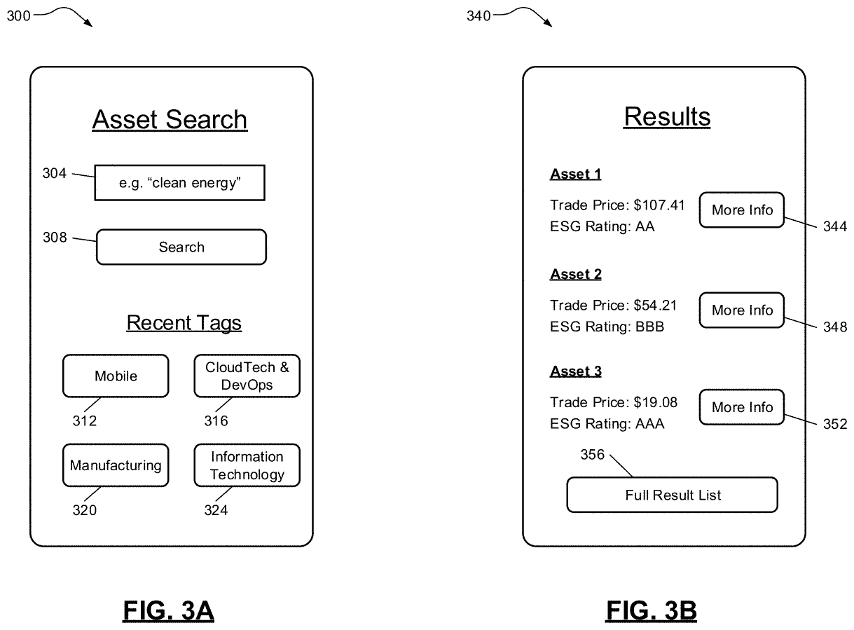

FIGS. 3A-3B are representations of example user interfaces presenting a search for particular securities. FIG. 3A depicts an asset search page 300 where a user can input a query into a search field 304 and select a search button 308 to retrieve results. In various implementations, the asset search page 300 may include a set of recent tags, including a mobile button 312, a CloudTech & DevOps button 316, manufacturing button 320, and an information technology button 324. Upon selection of one of the buttons, a search is performed for securities or entities including the corresponding tag.

Otherwise, if the user inputs a query such as, for example, “clean energy,” the recommendation generation system 100 of FIG. 1 implements a machine learning algorithm, such as natural language processing, to identify securities or entities that are related to clean energy based on the aggregated data across the plurality of databases integrated into the aggregated database 116. In various implementations, the query and corresponding results may be stored in the aggregated database 116 as associated with the user performing the search, suggesting user interest in the items searched.

Once the search button 308 is selected or a tag is selected, a results list 340 is displayed on the user interface of the user device 104, as shown in FIG. 3B. The results list 340 includes asset 1, asset 2, and asset 3, each corresponding to a particular security/entity. In various implementations, the results list 340 lists, for each trade, a trade price and an environmental, social, and corporate governance (ESG) rating. Additionally or alternatively, other information about the trades may be included in the results list 340. In various implementations, the information included in the results list 340 may be based on the text in the query. Each trade includes a more info button 344, 348, and 352. Upon selection of one of the more info buttons 344, 348, and 352, the user is presented with additional information about the trade, such as performance history. In various implementations, a full result list button 356 may be selected to show to the user other trade choices.

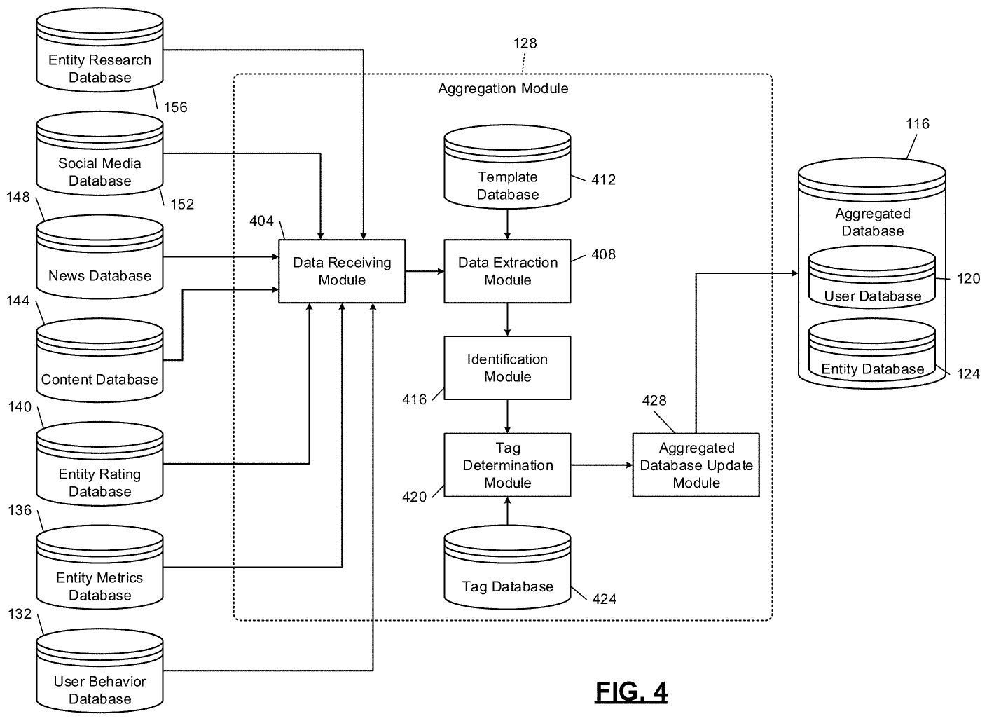

FIG. 4 is a functional block diagram of an example aggregation module 128. The aggregation module 128 includes a data receiving module 404 configured to receive data updates from the user behavior database 132, the entity metrics database 136, the entity rating database 140, the content database 144, the news database 148, the social media database 152, and the entity research database 156. In various implementations, the data receiving module 404 may also receive queries from the user device 104 of FIG. 1 to add to the aggregated database 116 to monitor and consider user searches.

The data receiving module 404 obtains the data and identifies a data source from which the data is received. In various implementations, such as with the news database 148 and the social media database 152 the data receiving module 404 may be obtaining data in real-time as social media posts are being posted and as news articles or content are being uploaded. While FIG. 4 depicts the data receiving module 404 as directly receiving data from the various databases, the data receiving module 404 may be receiving data via the Internet.

Similar to the news database 148 and the social media database 152, the data receiving module 404 may also be receiving data from the user behavior database 132 in real-time, monitoring user interaction with the financial platform. While data from the remaining databases may also be received in real-time, updates to the databases may not require real-time updates. Therefore, the aggregation module 128 may be configured to obtain data from the remaining databases at preset intervals, for example, daily.

Once the data is obtained and the data source is identified, the data receiving module 404 forwards the data and an indication of the data source to the data extraction module 408. The data extraction module 408 obtains a corresponding template for the data from a template database 412 based on the data source. That is, for each data source, the template database 412 includes a corresponding template to instruct the data extraction module 408 how and what to extract from the data. The template may indicate the form of the data and where particular identifiers or fields are in order to integrate the data into the aggregated database 116 in a uniform manner. Once the data is extracted according to the appropriate template, the data extraction module 408 forwards the extracted data to an identification module 416. The identification module 416 determines a user or entity to which the extracted data corresponds.

In various implementations, the aggregation module 128 may include a tag determination module 420. The tag determination module 420 receives the extracted data and indication of whether the data relates to a user, an entity, or both. The tag determination module 420 may identify tags within the extracted data based on preset tags stored in a tag database 424. In various implementations, the extracted data may already include tags. However, the tag determination module 420 may identify additional or different tags to include in the extracted data. The tag determination module 420 may add an identifier corresponding to each tag associated with data added to the aggregated database 116.

The tag determination module 420 forwards the extracted data, including any additional, tag identifiers, and the indication of a user, an entity, or both to an aggregated database update module 428. The aggregated database update module 428 then adds the extracted data to the aggregated database 116. In various implementations, the aggregated database update module 428 adds the extracted data to one or both of the user database 120 and the entity database 124 according to the indication determined by the identification module 416. The aggregated database update module 428 may include a timestamp with the data to allow more recent data to be more heavily weighted. In various implementations, depending on the data source, the aggregated database update module 428 may replace data included in the aggregated database 116. For example, an ESG rating may be updated for a particular entity. The new ESG rating may replace or supplement the previous ESG rating.

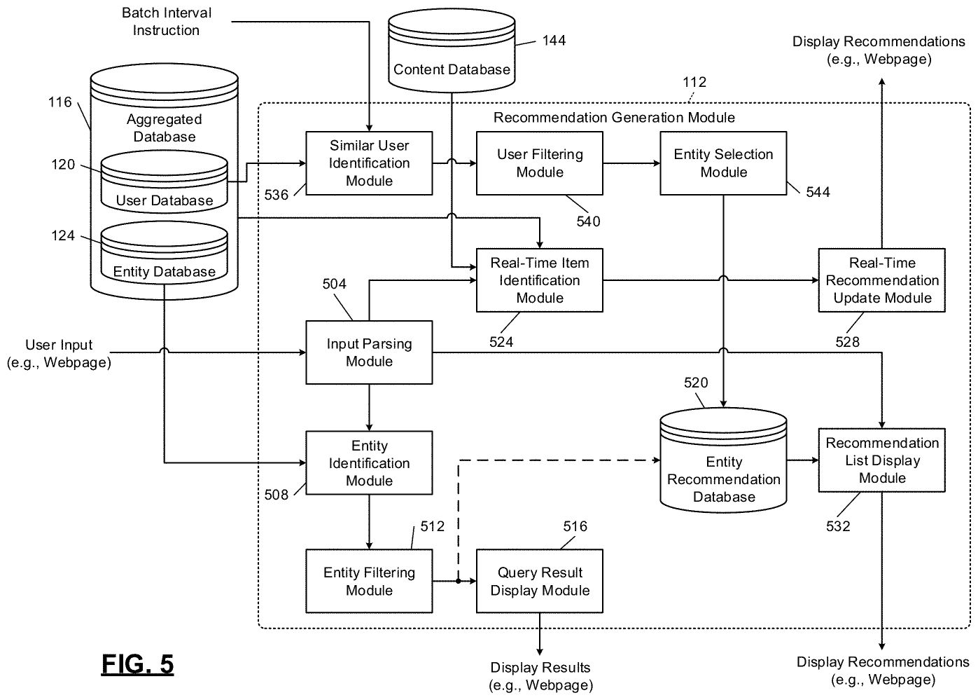

FIG. 5 is a functional block diagram of an example recommendation generation module 112. The recommendation generation module 112 may receive a variety of user input from the webpage via a user device. For example, the recommendation generation module 112 may receive user input in the form of a query, as shown in FIG. 3A, or in the form of clicks, such as navigating to particular webpages of an account corresponding to a user. The recommendation generation module 112 includes an input parsing module 504 configured to receive user input from a webpage.

The input parsing module 504 identifies whether the user input is a query sent by the user to navigate to a result page, a user click navigating to a webpage including similar user recommendations, or a user click navigating to a webpage including real-time content recommendations. If the input parsing module 504 determines the user entered a query and is being navigated to a result page (for example, the result list of FIG. 3B), the user input is forwarded to an entity identification module 508. The entity identification module 508 obtains data corresponding to a plurality of entities from the entity database 124. The entity identification module 508 identifies a set of entities that are related to the user input.

In various implementations, the entity identification module 508 implements a machine learning algorithm such as natural language processing, on (i) the user input, which can include terms, phrases, letters, numbers, etc. and (ii) the aggregated entity to identify the set of entities. The set of entities are forwarded to the entity filtering module 512 to remove entities already included in the user's portfolio. In various implementations, the entity filtering module 512 may further remove entities based on a historical performance over a set period of time, such as a previous six months, if performance was poor. However, removing entities based on performance may not be preferred because entities may always recover. In various implementations, the entity filtering module 512 is excluded.

The filtered entities are forwarded to a query result display module 516 to transmit and display results on a user interface of the user device, for example, on a webpage. In various implementations, the entity filtering module 512 also forwards the set of filtered entities to an entity recommendation database 520, which stores a set of entity recommendations for the plurality of users that interact with the platform or have an account through the financial entity. In various implementations, the query from the user is only used for the present search and the set of filtered entities is not stored in the entity recommendation database 520 for future use.

The input parsing module 504 may determine that the user is navigating through a variety of different webpages of the financial entity and, based on the previous page and the present page, forward the navigation information to a real-time item identification module 524. The real-time item identification module 524 may identify a next page to recommend to the user based on the present navigation information and data stored in the aggregated database 116. For example, based on the present navigation of the user, the real-time item identification module 524 may identify other pages that user has navigated to after following the present navigation path of the user. Additionally or alternatively, the real-time item identification module 524 may identify securities to recommend to the user if the present navigation of the user indicates a particular entity or a particular type of entity. In various implementations, the real-time item identification module 524 implements machine learning algorithms to anticipate a next webpage the user might want to view.

For example, the real-time item identification module 524 can monitor present navigation and previous user behavior aggregated into the user database 120 and determine a probability of navigating to a next page or a probability of placing a trade within the next week. The real-time item identification module 524 may also obtain a content item from the content database 144 (in various implementations, the news database 148 or other database may be accessed) based on the determined probability of navigating to the next page or the probability of placing a trade within the next week.

For example, the real-time item identification module 524 may identify an article for users new to trading if the probability is high that the user will place a trade soon. An indicator of the identified content item is forwarded to a real-time recommendation update module 528 to generate and display a link to the content item on the webpage. For example, the link may be displayed on a banner of the webpage or in an area of the webpage for advertised articles. In this way, the recommendation generation module 112 also anticipates, in real-time, content the user might be interested in viewing.

The user input of the user navigating to a variety of webpages may be forwarded to a recommendation list display module 532. The recommendation list display module 532 obtains, for the user, a recommendation list stored in the entity recommendation database 520 when the user navigates to a particular page, such as the homepage of FIG. 2A. The entity recommendation database 520 is updated in response to a batch interval instruction. The batch interval instruction may be sent every hour or daily to update the entity recommendations for each user based on the aggregated data from a plurality of databases. A similar user identification module 536 of the recommendation generation module 112 receives the batch interval instruction.

The similar user identification module 536 obtains aggregated data of users stored in the user database 120. For each user included in the user database 120, the similar user identification module 536 represents each user as a feature vector of attributes using the aggregated data, including portfolio structure, etc. The similar user identification module 536 identifies which users are similar based on the generated feature vectors, for example, using a k-nearest neighbors algorithm or other machine learning algorithm. The similar user identification module 536 identifies those users within a certain distance threshold of every other user. In various implementations, the similar user identification module 536 may also receive entity information from the entity database 124 and generate entity feature vectors to identify entities similar to a user. Then, the recommendation generation module 112 can recommend securities associated with similar entities.

Once a set of similar users is identified, for example, a top 1% of users most similar to a user, the set of users and their corresponding portfolio structure is forwarded to a user filtering module 540. The user filtering module 540 removes any users whose portfolio structure is too different from the user. For example, a similar user whose performance is 90% better than the user may be invested in higher risk options, which may be outside of the user's desired risk tolerance. Therefore, the user filtering module 540 may filter out users who perform worse than the user and those who perform over 10% better than the user to attempt to match the user's investment strategy. The filtered set of users is forwarded to an entity selection module 544. The entity selection module 544 identifies a set of entities to recommend to the user corresponding to the portfolios of the filtered set of similar users.

For example, if each user of the filtered set of similar users is invested in XYZ, the entity selection module 544 may select XYZ to recommend to the user. In various implementations, the entity selection module 544 may select each entity in which the filtered set of similar users has purchased. The selected entities are forwarded to the entity recommendation database 520 and indexed by user. As noted previously, the recommendation list display module 532 obtains the recommended entities for a user interacting with the platform, for example, when the user navigates to the homepage 200 of FIG. 2A, and displays the list of recommended entities. In various implementations, the query result display module 516, the real-time recommendation update module 528, and the recommendation list display module 532 can be implemented by a single output module.

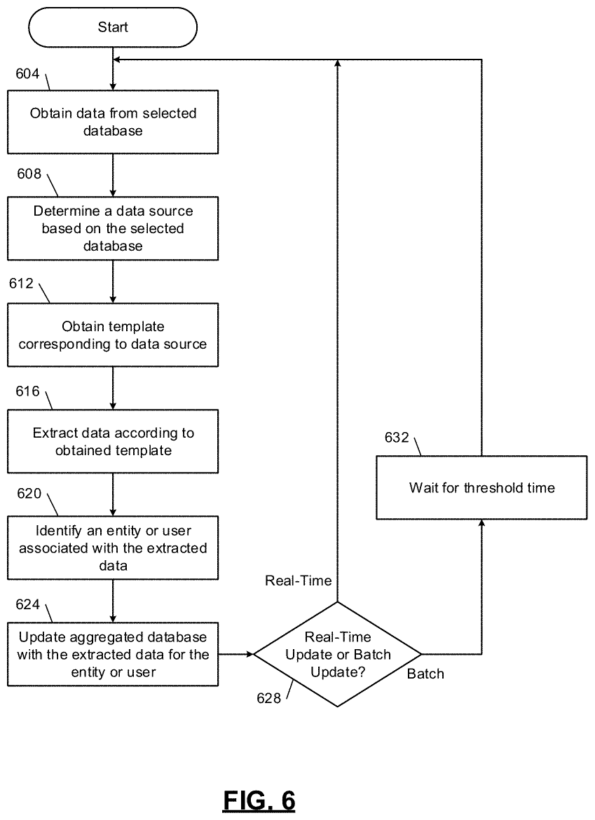

FIG. 6 is a flowchart depicting example data aggregation from a plurality of databases. Control depicts how data is aggregated from a database in real-time mode or in batch mode. Control beings at 604 to obtain data from a selected database. As described previously data is obtained from a plurality of databases. FIG. 6 depicts how data can be obtained from any of the databases described in the present disclosure. Control continues to 608 to determine a data source based on the selected database. Control proceeds to 612 to obtain a template corresponding to the data source. As described previously, each data source has a corresponding template to create an aggregated database that is uniform. Control continues to 616 to extract data from the selected database according to the obtained template.

At 620, control identifies whether an entity or a user is associated with the extracted data. For example, the template may indicate instructions to extract an identifier for an entity or user located in a particular field code. Control proceeds to 624 to update the aggregated database with the extracted data for the entity or user. As mentioned previously, the aggregated database may be indexed by entity or user identifier. Control continues to 628 to determine if the selected database is updated in real-time or in batch format. If real-time, control returns to 604 to obtain and aggregate data in real-time. For example, data is obtained in real-time for news or social media. Otherwise, if at 628 control determines that the selected database is aggregated into the aggregated database in batch format, control proceeds to 632 to wait for a corresponding threshold time. For example, the threshold time may be one hour or one day. In various implementations, the threshold may be expressed using different units than time. For example, the threshold be a total number of updates to the aggregated database—this will cause the threshold to be reached more quickly when updates are occurring more rapidly. Control then returns to 604.

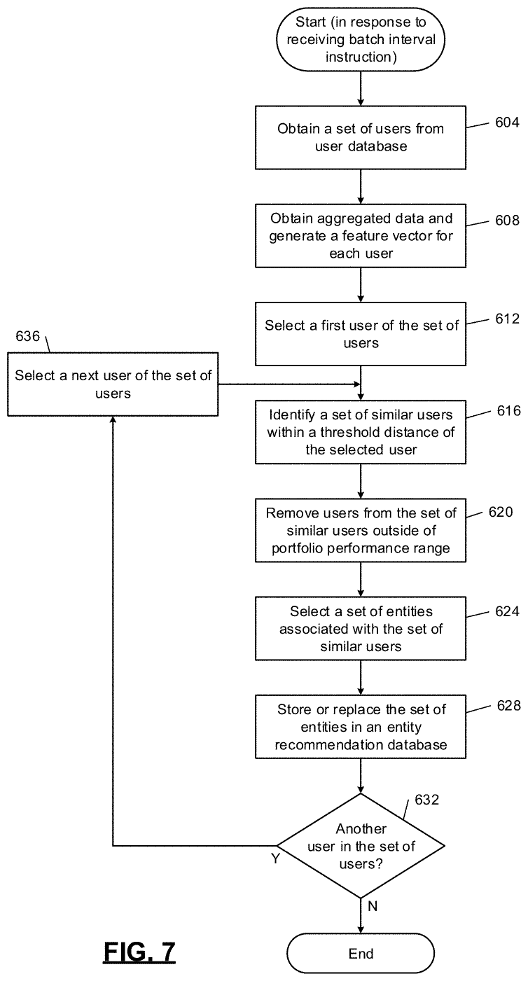

FIG. 7 is a flowchart depicting example updating a recommended investment list based on similar users. Control begins in response to receiving a batch interval instruction. Control continues to 704 to obtain a set of users from a user database. Control proceeds to 608 to obtain aggregated data and generate a feature vector for each user. At 612, control selects a first user of the set of users. Control continues to 616 to identify a set of similar users within a threshold distance of the selected user. Control proceeds to 620 to remove users from the set of similar users that are outside of a portfolio performance range.

As described previously, the selected user may only be interested in investments that match or are better than the user's performance. However, the user may not be interested in those investments that result in extremely better performance than the selected user as that may indicate that the similar user has a higher risk tolerance. Therefore, control, at 620, removes similar users performing worse than the selected user and those performing significantly better than the selected user, for example, more than 10% better than the selected user.

Control then continues to 624 to select a set of entities associated with the set of similar users. Control proceeds to 628 to store or replace the set of entities in an entity recommendation database. The set of entities will correspond to the selected user so that the set of entities will be displayed to the user as a recommended set of entities. Control proceeds to 632 to determine if another user is in the set of users. If no, control ends. Otherwise, control proceeds to 636 to select a next user of the set of users and returns to 616.

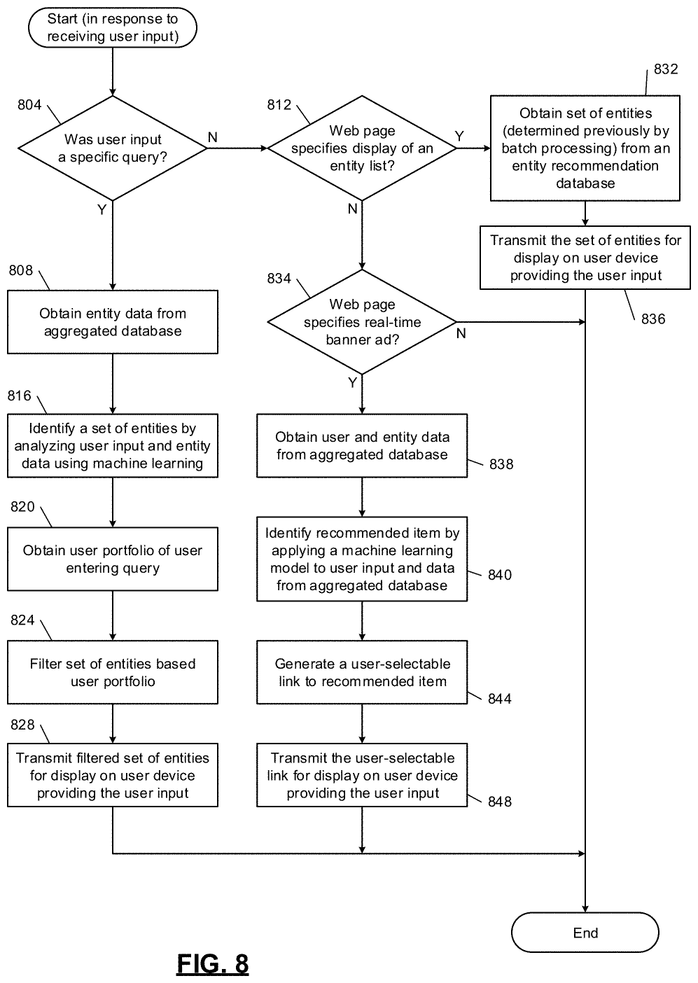

FIG. 8 is a flowchart depicting example recommended content or entities displayed on a user interface. Control begins in response to receiving user input. For example, the user input could include the user entering a search query to identify particular entities. As another example, the user input may include browsing a website of the financial platform by clicking from page to page. At 804, control determines if the user input is a specific query or is more general browsing. If the user input is a specific query, control proceeds to 808; otherwise, control proceeds to 812.

At 808, control obtains entity data from an aggregated database. The entity data corresponds to a plurality of entities that can be traded on the financial platform. Control continues to 816 to identify a set of entities by analyzing the user input and entity data using machine learning. As described above, the user input and entity data may be analyzed using natural language processing.

Control continues to 820 to obtain a user portfolio of the user entering the query, if available. At 824, control filters the set of entities based on the user portfolio. For example, the set of entities may be filtered by removing entities that the user is already invested in or may only keep entities that are similar to those entities in the user's portfolio. In various implementations, the set of entities is not filtered. Control continues to 828 to transmit and display the filtered set of entities on the user interface of the user device. Then, control ends.

Returning to 812, the user input indicates browsing to a new page (the target page). At 812, control determines whether the target page specifies display of a recommended entity list. If so, control transfers to 832; otherwise, control transfers to 834.

At 832, control obtains a set of entities from an entity recommendation database for the user identifier representing the user generating the user input. In various implementations, the set of entities was previously determined for multiple user identifiers at once as a batch. Control proceeds to 836 to transmit and display the set of entities to the user device that provided the user input. Then, control ends.

At 834, control determines whether the target web page specifies a real-time banner ad. If so, control transfers to 838; otherwise, control ends. At 838, control obtains user and entity data from the aggregated database. Control continues to 840 to identify a recommended item by applying a machine learning model to the user input and the data from the aggregated database. As described previously, the recommended item may be a content item, a news article, etc. recommended to the user based on the user's monitored interaction with the financial platform. Control continues to 844 to generate a user-selectable link to the recommended item. Control proceeds to 848 to transmit and display the user-selectable link to the user device transmitting the user input. Then, control ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. The phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An asset recommendation system comprising:
at least one processor; and
a memory coupled to the at least one processor,
wherein the memory stores:
an aggregated database including a plurality of user identifiers, wherein the plurality of user identifiers correspond to user information; and
instructions for execution by the at least one processor, and
wherein the instructions include:
for each user identifier of the plurality of user identifiers, generating a user representation based on the user information included in the aggregated database;
identifying, from the user representations of the plurality of user identifiers, a set of similar user representations based on a first user representation corresponding to a first user identifier;
obtaining, for a set of similar user identifiers corresponding to the set of similar user representations, a set of asset identifiers associated with the set of similar user identifiers; and
transforming an interface of a user device of the first user identifier by rendering a graphical depiction of the set of assets identifiers.

2. The asset recommendation system of claim 1 wherein:
the aggregated database includes a plurality of entity identifiers,
the plurality of entity identifiers correspond to entity information, and
the instructions include:
for each entity identifier of the plurality of entity identifiers, generating an entity representation based on the entity information included in the aggregated database,
identifying, from the entity representations of the plurality of entity identifiers, a set of similar entity representations based on the first user representation, and
including a set of entity identifiers corresponding to the set of similar entity representations in the set of assets identifiers.

3. The asset recommendation system of claim 2 wherein the instructions include, in response to receiving a query from the user device:
identifying the set of similar entity representations based on the query.

4. The asset recommendation system of claim 2 wherein the instructions include updating the aggregated database by:
retrieving user information and entity information from a plurality of databases, and
integrating the user information and entity information into the aggregated database using a corresponding template.

5. The asset recommendation system of claim 4 wherein:
each database of the plurality of databases corresponds to a template, and
the template includes instructs to normalize data retrieved from the corresponding database.

6. The asset recommendation system of claim 4 wherein the aggregated database is updated with data from a first set of databases of the plurality of databases in real-time and data from a second set of databases of the plurality of databases at threshold intervals.

7. The asset recommendation system of claim 1 wherein the instructions include:
obtaining, for the set of similar user identifiers, a performance history of a corresponding similar user portfolio over a threshold period,
obtaining, for the first user identifier, a first user performance history of a first user portfolio over the threshold period, and
removing user identifiers from the set of similar user identifiers in response to the corresponding performance history of the corresponding similar user portfolio being less than the first user performance history of the first user portfolio.

8. The asset recommendation system of claim 7 wherein the performance history indicates a total asset value change over the threshold period.

9. The asset recommendation system of claim 1 wherein the instructions include:
filtering the set of assets identifiers based on a performance history over a threshold period.

10. The asset recommendation system of claim 1 wherein the instructions include:
updating the set of similar user identifiers for each user identifier of the plurality of user identifiers at a threshold interval.

11. An asset recommendation method comprising:
for each user identifier of a plurality of user identifiers, generating a user representation based on user information included in an aggregated database, wherein the aggregated database includes the plurality of user identifiers, and wherein the plurality of user identifiers correspond to user information;
identifying, from the user representations of the plurality of user identifiers, a set of similar user representations based on a first user representation corresponding to a first user identifier;
obtaining, for a set of similar user identifiers corresponding to the set of similar user representations, a set of asset identifiers associated with the set of similar user identifiers; and
transforming an interface of a user device of the first user identifier by rendering a graphical depiction of the set of assets identifiers.

12. The asset recommendation method of claim 11 further comprising:
for each entity identifier of a plurality of entity identifiers, generating an entity representation based on entity information included in the aggregated database, wherein the aggregated database includes the plurality of entity identifiers, and wherein the plurality of entity identifiers correspond to entity information;
identifying, from the entity representations of the plurality of entity identifiers, a set of similar entity representations based on the first user representation; and
including a set of entity identifiers corresponding to the set of similar entity representations in the set of assets identifiers.

13. The asset recommendation method of claim 12 further comprising, in response to receiving a query from the user device:
identifying the set of similar entity representations based on the query.

14. The asset recommendation method of claim 12 further comprising updating the aggregated database by:
retrieving user information and entity information from a plurality of databases, and
integrating the user information and entity information into the aggregated database using a corresponding template.

15. The asset recommendation method of claim 14 wherein:
each database of the plurality of databases corresponds to a template, and
the template includes instructs to normalize data retrieved from the corresponding database.

16. The asset recommendation method of claim 14 wherein the aggregated database is updated with data from a first set of databases of the plurality of databases in real-time and data from a second set of databases of the plurality of databases at threshold intervals.

17. The asset recommendation method of claim 11 further comprising:
obtaining, for the set of similar user identifiers, a performance history of a corresponding similar user portfolio over a threshold period;
obtaining, for the first user identifier, a first user performance history of a first user portfolio over the threshold period; and
removing user identifiers from the set of similar user identifiers in response to the corresponding performance history of the corresponding similar user portfolio being less than the first user performance history of the first user portfolio.

18. The asset recommendation method of claim 17 wherein the performance history indicates a total asset value change over the threshold period.

19. The asset recommendation method of claim 11 further comprising:
filtering the set of assets identifiers based on a performance history over a threshold period.

20. The asset recommendation method of claim 11 further comprising:
updating the set of similar user identifiers for each user identifier of the plurality of user identifiers at a threshold interval.
